(19) United States
(12) Patent Application Publication
(10) Pub. No.: US 2015/0109360 A1
(43) Pub. Date: Apr. 23, 2015

(54) COLOR CONVERSION PROCESSING APPARATUS, COLOR CONVERSION PROCESSING METHOD, AND NON-TRANSITORY STORAGE MEDIUM

(71) Applicant: FUJIFILM Corporation, Tokyo (JP)

(72) Inventor: Eiji TERAUE, Minato-ku (JP)

(73) Assignee: FUJIFILM Corporation, Tokyo (JP)

(21) Appl. No.: 14/515,658

(22) Filed: Oct. 16, 2014

(30) Foreign Application Priority Data
Oct. 17, 2013 (JP) 2013-215924

(51) Int. Cl. H04N 1/60

(52) U.S. Cl. CPC H04N 1/6002; H04N 1/6075
USPC 347/5

(57) ABSTRACT

A color conversion processing apparatus calculates a hue angle of a spot color based on spot color information that defines the spot color, and then determines a spot color converting condition depending on the hue angle. The color conversion processing apparatus converts an original image signal of a spot color plate into an auxiliary-component image signal representing a color component of a process color plate according to the determined spot color converting condition.

### CROSS-REFERENCE TO RELATED APPLICATION

This application is based upon and claims the benefit of priority from Japanese Patent Application No. 2013-215924 filed on Oct. 17, 2013, the contents of which are incorporated herein by reference.

### BACKGROUND OF THE INVENTION

1. Field of the Invention

The present invention relates to a color conversion processing apparatus and a color conversion processing method for converting input image signals composed of image signals of process color plates and an image signal of a spot color plate into output image signals of process color plates, and a non-transitory storage medium that stores a program for such image signal conversion.

2. Description of the Related Art

Heretofore, it has occasionally been the practice in the printing field to print a color image based on image signals of color plates in C, M, Y, K (hereinafter referred to as “process color plates”) and a color plate in a spot color (hereinafter referred to as “spot color plate”). On condition a printing press that is unable to perform spot color printing is used to print the color image, then since the printing press is incompatible with the image signals, it is necessary to convert input image signals, which are made up of process color plates and a spot color plate, into output image signals made up of process color plates.

Recently, producers have been making growing demands for the use of not only spot colors but also colors similar thereto for the reason of diversified product designs. There have been proposed various color conversion processes taking into account color reproduction characteristics at the intermediate levels of spot color plates. For example, Japanese Laid-Open Patent Publication No. 2002-320095 and Japanese Laid-Open Patent Publication No. 2002-320096 disclose processes of correcting colors using a so-called dot gain curve before the color separation of a spot color is carried out.

### SUMMARY OF THE INVENTION

However, the processes disclosed in Japanese Laid-Open Patent Publication No. 2002-320095 and Japanese Laid-Open Patent Publication No. 2002-320096 allow for the adjustment of the lightness (shading) of a spot color plate, but do not take into account anything about the adjustment of saturation. In other words, the disclosed processes may occasionally cause a saturation shift depending on the combination of process color plates and a spot color plate, resulting in a reduction in the color reproduction characteristics at the intermediate level of the spot color plate.

The present invention has been made with a view toward solving the above problems. It is an object of the present invention to provide a color conversion processing apparatus, a color conversion processing method, and a non-transitory storage medium which are capable of realizing high color reproduction characteristics at the intermediate level of a spot color plate in a case where input image signals composed of image signals of process color plates and an image signal of a spot color plate are converted into output image signals of process color plates.

According to the present invention, a color conversion processing apparatus is provided for converting input image signals, which include original image signals of process color plates and an original image signal of a spot color plate, into output image signals of process color plates. The color conversion processing apparatus comprises a hue angle calculator configured to calculate a hue angle of a spot color based on spot color information that defines the spot color, a spot color converting condition determiner configured to determine a spot color converting condition depending on the hue angle that is calculated by the hue angle calculator, and a color conversion processor configured to convert the original image signal of the spot color plate into an auxiliary-component image signal representing a color component of a process color plate according to the spot color converting condition that is determined by the spot color converting condition determiner.

Since the color conversion processing apparatus has the color conversion processor for converting the original image signal of the spot color plate into the auxiliary-component image signal representing the color component of the process color plate according to the spot color converting condition that is determined depending on the hue angle of the spot color, the color conversion processing apparatus can perform an appropriate color conversion process considering the tendency that the color reproduction characteristics based on the process color plates differ depending on the hue angle. Consequently, high color reproduction characteristics can be realized at the intermediate level of the spot color plate in converting the input image signals of the process color plates and the spot color plate into the output image signals of the process color plates.

The color conversion processor preferably comprises a first color converter configured to convert the original image signal of the spot color plate into an intermediate image signal of a device-independent color plate, using the spot color converting condition, and a second color converter configured to convert the intermediate image signal that is converted by the first color converter into the auxiliary-component image signal by having an output profile act thereon.

The spot color converting condition determiner preferably classifies an entire range that can be taken by the hue angle into a plurality of partial ranges, and determines the spot color converting condition depending on whether the hue angle belongs to either one of the partial ranges or not.

The spot color converting condition determiner preferably determines a gradation conversion characteristic curve representing a relationship between a gradation level of the spot color plate and color components that define a device-independent color, as the spot color converting condition.

The spot color converting condition determiner preferably determines the gradation conversion characteristic curve which converts a lowest level of the spot color plate into color values of an output medium and converts a highest level of the spot color plate into color values of the spot color, as the spot color converting condition.

The color conversion processing apparatus preferably further comprises a process color converter configured to convert the original image signals of the process color plates into main-component image signals of process color plates by having an input profile and an output profile act successively thereon, and a signal adder configured to add the auxiliary-component image signal converted by the color conversion processor to the main-component image signals converted by the process color converter to obtain the output image signals.

According to the present invention, there is also provided a color conversion processing method for converting input image signals, which include original image signals of process color plates and an original image signal of a spot color plate, into output image signals of process color plates, the color conversion processing method enabling a computer to perform the steps of calculating a hue angle of a spot color based on spot color information that defines the spot color, determining a spot color converting condition depending on the calculated hue angle, and converting the original image signal of the spot color plate into an auxiliary-component image signal representing a color component of a process color plate according to the determined spot color converting condition.

According to the present invention, there is further provided a non-transitory storage medium storing a color conversion processing program for converting input image signals, which include original image signals of process color plates and an original image signal of a spot color plate, into output image signals of process color plates, the color conversion processing program enabling a computer to perform the steps of calculating a hue angle of a spot color based on spot color information that defines the spot color, determining a spot color converting condition depending on the calculated hue angle, and converting the original image signal of the spot color plate into an auxiliary-component image signal representing a color component of a process color plate according to the determined spot color converting condition.

With the color conversion processing apparatus, the color conversion processing method, and the non-transitory storage medium according to the present invention, inasmuch as the original image signal of the spot color plate is converted into the auxiliary-component image signal representing the color component of the process color plate according to the spot color converting condition that is determined depending on the hue angle of the spot color, an appropriate color conversion process can be performed considering the tendency that the color reproduction characteristics based on the process color plates differ depending on the hue angle. Consequently, high color reproduction characteristics can be realized at the intermediate level of the spot color plate in converting the input image signals of the process color plates and the spot color plate into the output image signals of the process color plates.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an overall block diagram of a print production system incorporating a color conversion processing apparatus according to an embodiment of the present invention;

FIG. 2 is an electric block diagram of the color conversion processing apparatus shown in FIG. 1;

FIG. 3A is a schematic front elevational view of a monochromatic color chart shown in FIG. 1;

FIG. 3B is a graph showing transition characteristics of color patch rows shown in FIG. 3A;

FIG. 4 is a flowchart of an operation sequence of the color conversion processing apparatus shown in FIGS. 1 and 2;

FIG. 5 is a diagram showing an example of classifications for a hue angle;

FIGS. 6A through 6C are diagrams illustrating a process of generating a spot color conversion table;

FIG. 7 is a detailed block diagram of a color conversion processor shown in FIG. 2; and

FIG. 8 is a graph showing a correction result according to a first color conversion process.

### DESCRIPTION OF THE PREFERRED EMBODIMENTS

A color conversion processing method according to a preferred embodiment of the present invention, in relation to a color conversion processing apparatus and a non-transitory storage medium that stores a color conversion processing program for carrying out the color conversion processing method, will be described in detail below with reference to the accompanying drawings.

### [Overall Configuration of Print Production System 10]

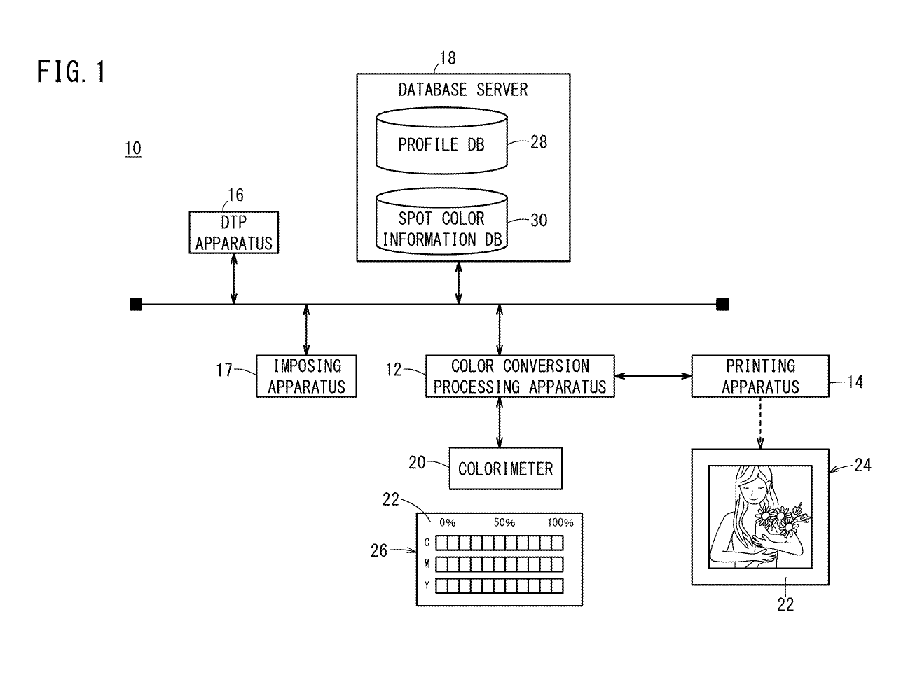

FIG. 1 is an overall block diagram of a print production system 10 incorporating a color conversion processing apparatus according to an embodiment of the present invention.

As shown in FIG. 1, the print production system 10 basically includes a color conversion processing apparatus 12, a printing apparatus 14, a DTP (DeskTop Publishing) apparatus 16, an imposing apparatus 17, and a database server 18. The color conversion processing apparatus 12, the DTP apparatus 16, the imposing apparatus 17, and the database server 18 are electrically connected to each other through a wired or wireless link.

The color conversion processing apparatus 12 converts image signals input from an external apparatus (hereinafter referred to as “input image signals”) into image signals suitable for printing by the printing apparatus 14 (hereinafter referred to as “output image signals”). The color conversion processing apparatus 12 outputs the converted image signals as output data to the printing apparatus 14. The input image signals are composed of image signals representing process color plates and a spot color plate. The process color plates imply four color plates (C, M, Y, K) or three color plates (C, M, Y), whereas the spot color plate implies a color plate (e.g., green or violet) that differs from the process colors.

A colorimeter 20 for measuring color values of an object to be measured is connected to the color conversion processing apparatus 12. The color values include not only tristimulus values X, Y, Z, coordinate values L*, a*, b* of a uniform color space, or the like, but also include characteristics of optical physical values with respect to wavelengths, e.g., a spectral radiation distribution, a spectral sensitivity distribution, a spectral reflectance, or a spectral transmittance. The color values, which are acquired by the colorimeter 20, may hereinafter be referred to as “colorimetric values”.

The printing apparatus 14 is connected electrically to the color conversion processing apparatus 12 through a serial interface such as a USB (Universal Serial Bus) cable, an IEEE1394 cable, an Ethernet (registered trademark) cable, a wireless network, or the like, or a parallel interface such as a Centronics cable.

Based on output data supplied from the color conversion processing apparatus 12, the printing apparatus 14 produces a print 24 (including a monochromatic color chart 26 to be described later) comprising an output medium 22 with an image formed thereon. The output medium 22 may comprise a paper medium such as synthetic paper, thick paper, aluminum-evaporated paper, or the like, a resin medium such as vinyl chloride, PET (polyethylene terephthalate), or the like, or tarpaulin paper, metal sheeting, or the like.

On condition the printing apparatus 14 comprises a proofer, then the printing apparatus 14 may comprise a DDCP (Direct Digital Color Proofer), an ink jet color proofer, a low-resolution color laser printer (electrophotographic printer), an ink jet printer, or the like.

On condition the printing apparatus 14 comprises a letterpress, then the printing apparatus 14 applies inks to the output medium 22 through printing plates and intermediate transfer members, not shown, thereby producing the print 24 with an image on the output medium 22.

On condition the printing apparatus 14 comprises a digital printer, then the printing apparatus 14 can produce the print 24 directly without the intermediary of printing plates. The digital printer may comprise an ink jet printer, a wide-format printer, an ink jet color proofer, a color laser printer, or the like.

The DTP apparatus 16 is an apparatus for performing a preflight process on contents data made up of characters, figures, pictures, photographs, etc. and generating data of each page (page data) from the contents data. The imposing apparatus 17 is an apparatus for performing an imposing process depending on a designated binding process or a sheet folding process, while referring to tag information of a job ticket, e.g., a JDF (Job Definition Format) file.

The database server 18 is a server apparatus for storing various data with respect to work flows. For example, the database server 18 may store content data, output data (e.g., platemaking data, printing plate data, or proofreading data), job tickets, e.g., JDF (Job Definition Format) files, color profiles, and spot color information, etc.

In FIG. 1, the database server 18 includes a database of color profiles (referred to simply as “profiles”) (hereinafter referred to as “profile DB 28”) and a database of spot color information (hereinafter referred to as a “spot color information DB 30”). The profile DB 28 comprises a collection of data that represent types of profiles and printing conditions which are related to each other. The spot color information DB 30 comprises a collection of data that represent spot color names and color values (e.g., L*, a*, b* values) which are related to each other.

### [Block Representation of Color Conversion Processing Apparatus 12]

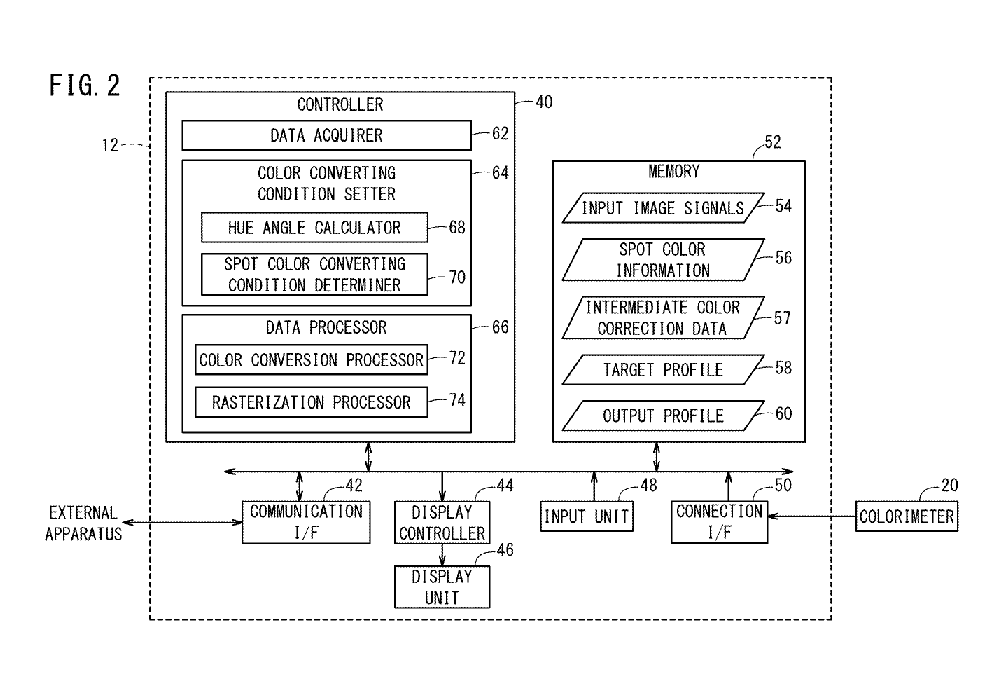

FIG. 2 is an electric block diagram of the color conversion processing apparatus 12 shown in FIG. 1. As shown in FIG. 2, the color conversion processing apparatus 12 comprises a computer, which includes a controller 40, a communication I/F 42, a display controller 44, a display unit 46, an input unit 48, a connection I/F 50, and a memory 52 (storage medium).

The communication I/F 42 is an interface (I/F) for sending electric signals to and receiving electric signals from external apparatus. Via the communication I/F 42, the color conversion processing apparatus 12 can acquire various data such as input image signals 54, for example, from the database server 18 (FIG. 1), and can supply various data such as an output profile 60, for example, to the database server 18.

The display controller 44 comprises a control circuit for controlling the display unit 46 under the control of the controller 40. More specifically, in a case where the display controller 44 outputs a display control signal to the display unit 46 via a non-illustrated interface, the display unit 46 is energized to display various images. The input unit 48 comprises various input devices including a mouse, a trackball, a keyboard, a touch sensor, etc. The display function of the display unit 46 and the input function of the input unit 48 are combined into a user interface.

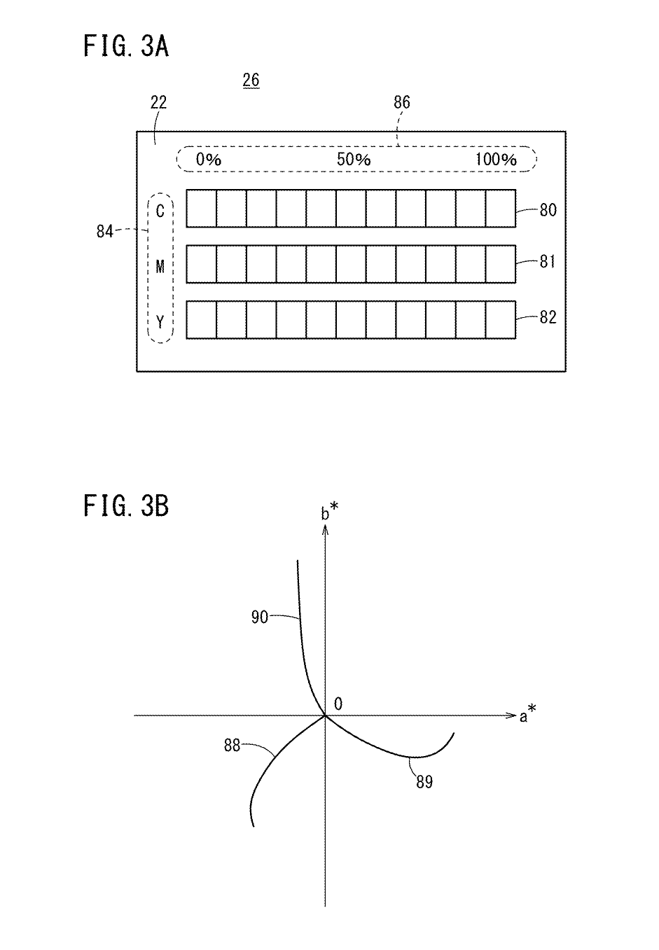

The connection I/F 50 is an interface for receiving colorimetric data from the colorimeter 20. Thus, the color conversion processing apparatus 12 can acquire colorimetric values of color patch rows 80, 81, 82 (FIG. 3A) via the colorimeter 20.

The memory 52 stores programs and data which are required for the controller 40 to control various components of the color conversion processing apparatus 12. In FIG. 2, the memory 52 stores the input image signals 54, spot color information 56, intermediate color correction data 57, a target profile 58 (input profile), and the output profile 60.

The memory 52 may comprise a computer-readable non-transitory storage medium. In this case, the computer-readable is a portable medium such as a magnetooptical disk, a ROM, a CD-ROM, a flash memory, or the like, or a storage device such as a hard disk that is incorporated in a computer system. The storage medium may hold programs dynamically over a short period of time or may hold programs for a prescribed period of time.

The controller 40 comprises a processor such as a CPU (Central Processing Unit) or the like. The controller 40 reads and executes programs stored in the memory 52 in order to perform the functions of a data acquirer 62, a color converting condition setter 64, and a data processor 66.

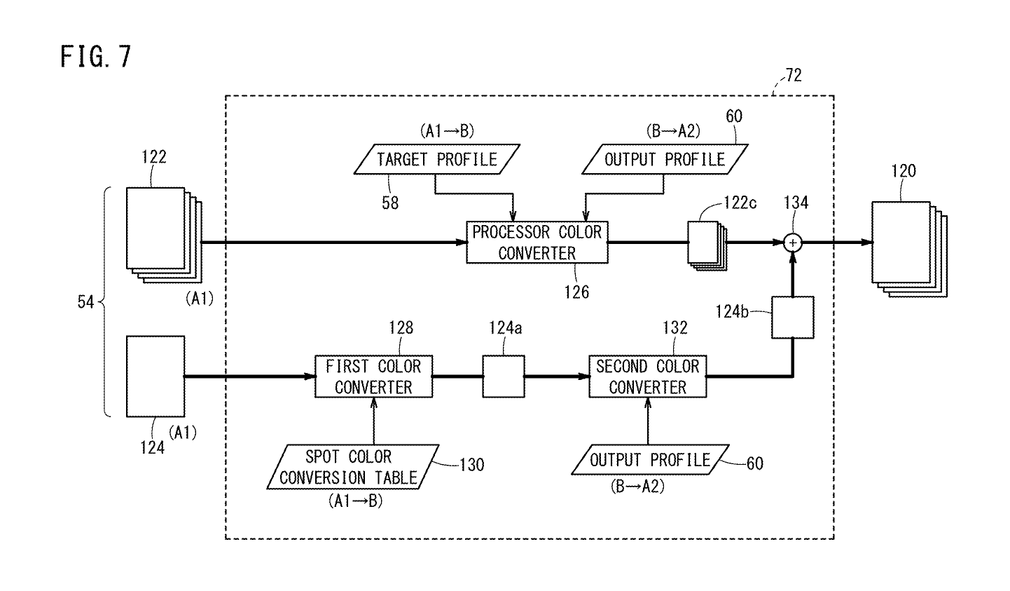

The data acquirer 62 acquires various data for performing a color conversion process on the input image signals 54. The data that are acquired by the data acquirer 62 include, in addition to the target profile 58 and the output profile 60, the spot color information 56 and the intermediate color correction data 57 for determining a spot color conversion table 130 (FIG. 7) to be described later.

The color converting condition setter 64 sets color converting conditions suitable for the input image signals 54, which serve as a target to be processed by a printing process. More specifically, the color converting condition setter 64 includes a hue angle calculator 68 for calculating a hue angle of a spot color and a spot color converting condition determiner 70 for determining spot color converting conditions (e.g., the spot color conversion table 130, see FIG. 7) depending on the hue angle.

The data processor 66 carries out data processing suitable for printing on the input image signals 54. More specifically, the data processor 66 includes a color conversion processor 72 for performing the color conversion process using various profiles and a rasterization processor 74 for converting a PDL (Page Description Language) format into a raster format.

### [Color Reproduction Characteristics of Spot Color]

According to the present embodiment, it is assumed that input image signals 54 of process color plates and a spot color plate are converted into output image signals 120 (FIG. 7) of process color plates. In the conversion process, the color reproduction characteristics at an intermediate level of the spot color plate may possibly be reduced depending on the combination of the process color plates and the spot color plate.

FIG. 3A is a schematic front elevational view of the monochromatic color chart 26 shown in FIG. 1. The monochromatic color chart 26 has three color patch rows 80, 81, 82 extending in a horizontal direction, a character string 84 extending in a vertical direction, and a character string 86 extending in the horizontal direction, all printed on the output medium 22. The character string 84 represents attributes of color plates (C, M, Y) used to produce the color patch rows 80, 81, 82. The character string 86 represents gradation levels (halftone %) of color patches belonging to the color patch rows 80, 81, 82. More specifically, the character string 86 indicates that the gradation levels of respective single colors change in increments of 10% from the left to the right.

FIG. 3B is a graph showing transition characteristics of the color patch rows 80, 81, 82 shown in FIG. 3A. The graph has a horizontal axis representing a* of the CIELAB color system and a vertical axis representing b* thereof.

In FIG. 3B, a transition curve 88 is a curve drawn by interconnecting the colorimetric values (a*, b*) of the color patch row 80 that represents the single color of cyan (C). A transition curve 89 is a curve drawn by interconnecting the colorimetric values (a*, b*) of the color patch row 81 that represents the single color of magenta (M). A transition curve 90 is a curve drawn by interconnecting the colorimetric values (a*, b*) of the color patch row 82 that represents the single color of yellow (Y).

As can be understood from FIG. 3B, the transition curve 90 according to the single color Y is of the highest linearity, whereas the transition curve 89 according to the single color M is of the lowest linearity. Stated otherwise, a saturation shift tends to be small in a range close to the hue angle of the single color Y, and a saturation shift tends to be large in a range close to the hue angle of the single color M.

The hue angle (or simply “hue”) represents an aspect of color, and serves as an index that may take a value within a range from 0 to 360 degrees. However, the hue angle is not limited to such a definition, but may be defined in various ways with a color system such as CIELUV, CIERGB, or the like.

As described above, on condition the linearity of a hue angle transition of a single process color is low, then in a case where a saturation shift occurs depending on the combination of process color plates and a spot color plate, a color irregularity and a color jump may become visible on a gradation image produced by the spot color plate. According to the present embodiment, a color conversion processing method is proposed to solve the above problems.

### [Operation of Color Conversion Processing Apparatus 12]

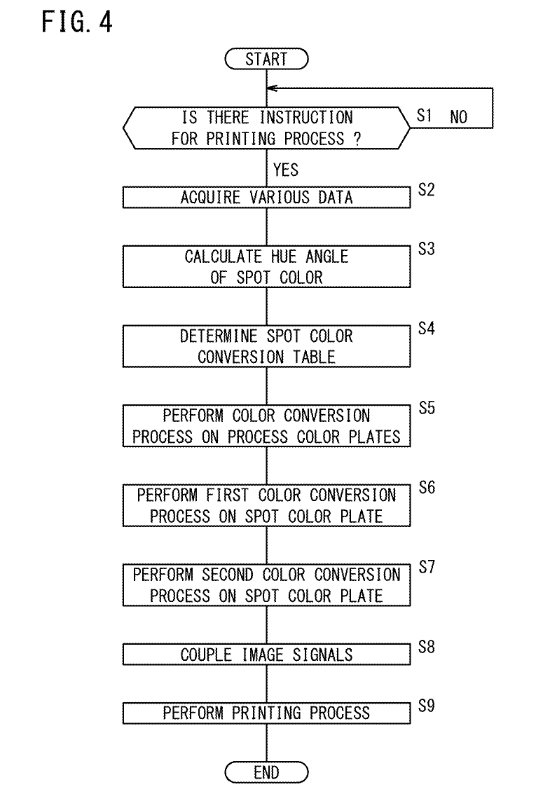

An operation sequence of the print production system 10 (particularly, the color conversion processing apparatus 12) will be described in detail below with reference to a flowchart shown in FIG. 4.

In step S1, the color conversion processing apparatus 12 judges whether there is an instruction for starting the printing process or not. On condition there is no instruction (step S1: NO), then the color conversion processing apparatus 12 loops step S1 until it receives an instruction. On condition there is an instruction (step S1: YES), then the color conversion processing apparatus 12 acquires input image signals 54 to be used in the printing process. Control then goes to next step S2.

In step S2, the data acquirer 62 acquires various data for performing a color conversion process on the input image signals 54. More specifically, the data acquirer 62 acquires the target profile 58 and the output profile 60 that are associated with the types of the printing apparatus 14 and the output medium 22 from the profile DB 28 (FIG. 1).

The data acquirer 62 also acquires the spot color information 56 and the intermediate color correction data 57 that are associated with the type of the printing apparatus 14, the type of the output medium 22, and the spot color name from the spot color information DB 30 (FIG. 1). The spot color information 56 should preferably be information indicating that the spot color can be defined by color values not dependent on an input/output device (so-called device-independent color values). More specifically, a color system such as HSV (Hue-Saturation-Value), HLS (Hue-Lightness-Saturation), CIELAB, CIELUV, XYZ, or the like may be used as the spot color information 56.

In step S3, the hue angle calculator 68 calculates a hue angle of the spot color based on the spot color information 56 that is acquired in step S2. On the CIELAB color system, a hue angle is calculated according to H=tan⁻¹(b*/a*) (0≦H<360 [degrees]). It is assumed hereinbelow that the spot color is a color close to violet (bluish-purple) and H=300 [degrees].

In step S4, the spot color converting condition determiner 70 determines a spot color conversion table 130 (one form of spot color converting conditions) depending on the hue angle that is calculated in step S3. More specifically, the spot color converting condition determiner 70 classifies an entire range that can be taken by the hue angle into a plurality of partial ranges (ranges 1 through 8), and selects correction quantities (Δa*, Δb*) depending on whether the hue angle belongs to any one of the partial ranges or not.

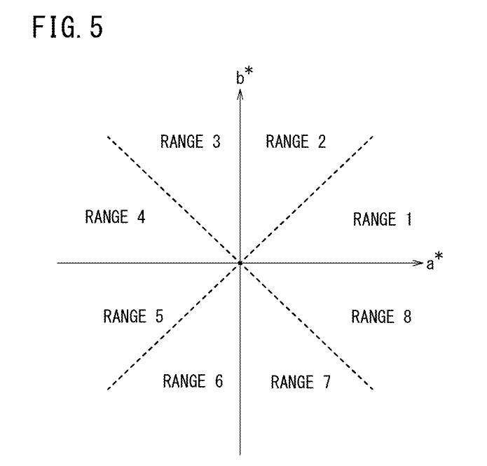

FIG. 5 is a diagram showing an example of classifications for the hue angle. On condition the hue angle (H) falls in a range 0≦H<45 [degrees], then it is classified into the “range 1”, and on condition the hue angle (H) falls in a range 45≦H<90 [degrees], then it is classified into the “range 2”. On condition the hue angle (H) falls in a range 90≦H<135 [degrees], then it is classified into the “range 3”, and on condition the hue angle (H) falls in a range 135≦H<180 [degrees], then it is classified into the “range 4”. On condition the hue angle (H) falls in a range 180≦H<225 [degrees], then on condition it is classified into the “range 5”, and on condition the hue angle (H) falls in a range 225≦H<270 [degrees], then it is classified into the “range 6”. On condition the hue angle (H) falls in a range 270≦H<315 [degrees], then it is classified into the “range 7”, and on condition the hue angle (H) falls in a range 315≦H<360 [degrees], then it is classified into the “range 8”.

As a result, the spot color converting condition determiner 70 reads and refers to the intermediate color correction data 57 that is acquired in step S2, and obtains the correction quantities (Δa*, Δb*) corresponding to the “range 7”. It is assumed that both the correction quantities (Δa*, Δb*) are of negative values.

The spot color converting condition determiner 70 determines gradation conversion characteristic curves 100, 106, 112 representing the relationship between the gradation level (0 through 100%) of the spot color plate and the color components (here, L*, a*, b*) that define a device-independent color.

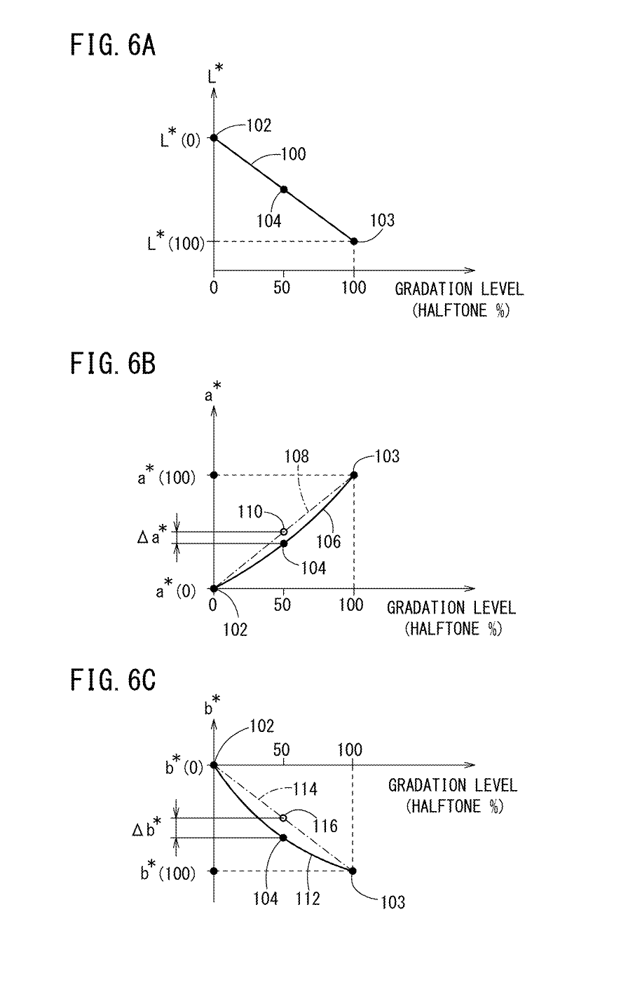

FIG. 6A is a graph showing the gradation conversion characteristic curve 100 that represents the relationship between the gradation level of the spot color plate and the first color component (L*). In FIG. 6A, L*(0) corresponds to the L* value of the output medium 22, whereas L*(100) corresponds to the L* value of the spot color.

The gradation conversion characteristic curve 100 is plotted as a straight line interconnecting a solid dot (closed dot) 102 that corresponds to the lowest gradation level (0%) and a solid dot 103 that corresponds to the highest gradation level (100%) and extending through a solid dot 104 that corresponds to a certain gradation level (e.g., 50%). It should be noted that the gradation conversion characteristic curve 100 is used as it is without being corrected.

FIG. 6B is a graph showing the gradation conversion characteristic curve 106 that represents the relationship between the gradation level of the spot color plate and the second color component (a*). In FIG. 6B, a*(0) corresponds to the a* value of the output medium 22 itself (unprinted area), whereas a*(100) corresponds to the a* value of the spot color.

The gradation conversion characteristic curve 106 is plotted as a quadratic curve having opposite ends at the respective solid dots 102, 103 and extending through the solid dot 104. A straight line indicated as a dot-and-dash line represents an ideal graduation characteristic curve (hereinafter referred to as “ideal graduation characteristic curve 108”) interconnecting the solid dots 102, 103. A blank dot (open dot) 110 on the ideal graduation characteristic curve 108 corresponds to the certain gradation level (e.g., 50%).

An a* value represented by the solid dot 104 is equal to the sum of an a* value {=(a*(0)+a*(100))/2} represented by the blank dot 110 and Δa*. Stated otherwise, the gradation conversion characteristic curve 106 can be obtained by correcting the ideal graduation characteristic curve 108.

FIG. 6C is a graph showing the gradation conversion characteristic curve 112 that represents the relationship between the gradation level of the spot color plate and the third color component (b*). In FIG. 6C, b*(0) corresponds to the b* value of the output medium 22, whereas b*(100) corresponds to the b* value of the spot color.

The gradation conversion characteristic curve 112 is plotted as a quadratic curve having opposite ends at the respective solid dots 102, 103 and extending through the solid dot 104. A straight line indicated as a dot-and-dash line represents an ideal graduation characteristic curve (hereinafter referred to as “ideal graduation characteristic curve 114”) interconnecting the solid dots 102, 103. A blank dot 116 on the ideal graduation characteristic curve 114 corresponds to the certain gradation level (e.g., 50%).

A b* value represented by the solid dot 104 is equal to the sum of a b* value {=(b*(0)+b*(100))/2} represented by the blank dot 116 and Δb*. Stated otherwise, the gradation conversion characteristic curve 112 can be obtained by correcting the ideal graduation characteristic curve 114.

As described above, the spot color converting condition determiner 70 classifies the entire range that can be taken by the hue angle into the plural partial ranges, and determines a spot color conversion table 130 depending on whether the hue angle belongs to any one of the partial ranges or not. In the example described above, the spot color converting condition determiner 70 uses the correction quantities (Δa*, Δb*) depending on the partial ranges in determining a spot color conversion table 130. However, the spot color converting condition determiner 70 is not limited to such a determining process.

The spot color converting condition determiner 70 may determine gradation conversion characteristic curves 100 (FIG. 6A), 106 (FIG. 6B), 112 (FIG. 6C) that represent the relationship between the gradation level (halftone %) of the spot color plate and the color components that define the device-independent color, as a spot color conversion table 130. In the exampled described above, the spot color conversion table 130 is a one-dimension-three-dimension conversion table made up of gradation conversion characteristic curves 100, 106, 112 combined together.

The spot color converting condition determiner 70 may determine a spot color conversion table 130 for converting the lowest gradation level (0%) of the spot color plate into the color values of the output medium 22 and converting the highest gradation level (100%) of the spot color plate into the color values of the spot color. The spot color conversion table 130 thus determined is capable of maintaining at least the color reproduction characteristics at the lowest and highest levels of the spot color plate.

In steps S5 through S8, the color conversion processor 72 obtains output image signals 120 by successively performing predetermined data processing. A specific example of the color conversion process will be described in detail below with reference to FIG. 7.

FIG. 7 is a detailed block diagram of the color conversion processor 72 shown in FIG. 2. The color conversion processor 72 converts input image signals 54 into output image signals 120 using color conversion information that includes the profiles. The input image signals 54 are composed of original image signals 122 of process color plates and an original image signal 124 of a spot color plate, and the output image signals 120 are composed of image signals of process color plates.

In FIG. 7, color reproduction characteristics represented by the image signals are denoted by symbols “A1”, “A2”, and “B” for illustrative purposes. The symbols “A1”, “A2”, and “B” represent a device-dependent color space specified by the target profile 58, a device-dependent color space specified by the output profile 60, and a device-independent color space, respectively.

A color conversion from the device-dependent color space (A) into the device-independent color space (B) will be referred to as “A2B conversion”, a color conversion from the device-independent color space (B) into the device-dependent color space (A) as “B2A conversion”, and a color conversion from the device-dependent color space (A) into the device-dependent color space (A) as “A2A conversion”.

In step S5 of FIG. 4, a process color converter 126 performs a color conversion process (A2A conversion) on the original image signals 122 of the process color plates by having a desired input profile (target profile 58) and the desired output profile 60 act successively thereon. The color conversion process comprises [1] an “A1→B” conversion based on the target profile 58 and [2] an “B→A2” conversion based on the output profile 60, which are successively coupled together. By performing the color conversion process, the process color converter 126 obtains image signals of process color plates (hereinafter referred to as “main-component image signals 122c”), which are suitable for the color reproduction characteristics (A2) of the printing apparatus 14.

In step S6 of FIG. 4, a first color converter 128 performs a first color conversion process (A2B conversion) on the original image signal 124 of the spot color plate using the spot color conversion table 130 that is determined in step S4. By performing the first color conversion process, the first color converter 128 obtains an image signal of a device-independent color plate (hereinafter referred to as “intermediate image signal 124a”) that agrees with the tendency of the transition curves 88, 89, 90 (FIG. 3B) in the combination of the printing apparatus 14 and the output medium 22.

In step S7 of FIG. 4, a second color converter 132 performs a second color conversion process (B2A conversion) on the intermediate image signal 124a of the device-independent color plate by having the desired output profile 60 act thereon. By performing the second color conversion process, the second color converter 132 obtains an image signal of a process color plate (hereinafter referred to as “auxiliary-component image signal 124b”) that is suitable for the color reproduction characteristics (A2) of the printing apparatus 14.

In step S8 of FIG. 4, a signal adder 134 adds the auxiliary-component image signal 124b converted by the second color converter 132 to the main-component image signals 122c converted by the process color converter 126. In this manner, the color conversion processor 72 obtains the output image signals 120 of process color plates.

In step S9, the printing process is carried out based on the output image signals 120 converted in color in step S8. Prior to the printing process, the rasterization processor 74 performs a rasterization process suitable for the printing apparatus 14 on the output image signals 120 to generate raster data, and supplies the generated raster data to the printing apparatus 14. The printing apparatus 14 then produces a desired print 24 based on the raster data.

The operation sequence of the print production system 10 (particularly, the color conversion processing apparatus 12) is now ended. Consequently, even the printing apparatus 14 which is not compatible with spot color printing, e.g., a proof press, is able to realize color reproduction characteristics, in substantially the same fashion as apparatus which are compatible with spot color printing.

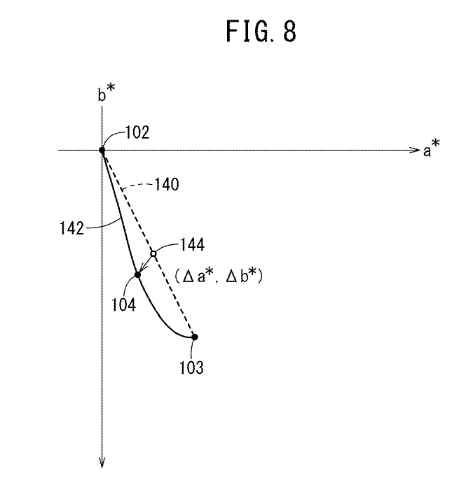

FIG. 8 is a graph showing a correction result according to the first color conversion process. The graph has a horizontal axis representing a* and a vertical axis representing b*. FIG. 8 illustrates transition characteristics of a color in a gradation image of the spot color plate (violet).

In FIG. 8, an ideal curve 140 is plotted as a straight line extending through a range from the lowest level (0%, solid dot 102) of the spot color to the highest level (100%, solid dot 103) thereof. A transition curve 142 is plotted as representing colorimetric values (a*, b*) in the full range from the solid dot 102 to the solid dot 103.

The ideal curve 140 represents color reproduction characteristics achieved in a case where a linear color conversion process is carried out rather than the first color conversion process. As can be seen from FIG. 8, the ideal curve 140 deviates from the actual transition curve 142 (solid dot 104) particularly at an intermediate gradation level (blank dot 144). In a case where the first color conversion process is carried out, the original image signal 124 is converted into the intermediate image signal 124a (FIG. 7) that agrees with the tendency of the transition curve 142. As a consequence, high color reproduction characteristics can be realized at the intermediate level of the spot color plate.

### [Advantages of the Present Embodiment]

As described above, the color conversion processing apparatus 12 according to the present embodiment is an apparatus for converting input image signals 54 composed of original image signals 122 of process color plates and an original image signal 124 of a spot color plate into output image signals 120 of process color plates.

The color conversion processing apparatus 12 includes the hue angle calculator 68 for calculating a hue angle of the spot color based on spot color information 56 that defines the spot color, the spot color converting condition determiner 70 for determining a spot color conversion table 130 depending on the hue angle, and the color conversion processor 72 for converting the original image signal 124 of the spot color plate into an auxiliary-component image signal 124b representing a color component of a process color plate according to the spot color conversion table 130.

Since the color conversion processing apparatus 12 has the color conversion processor 72 for converting the original image signal 124 of the spot color plate into the auxiliary-component image signal 124b according to the spot color conversion table 130 that is determined depending on the hue angle of the spot color, the color conversion processing apparatus 12 can perform an appropriate color conversion process considering the tendency that the color reproduction characteristics based on the process color plates differ depending on the hue angle. Consequently, high color reproduction characteristics can be realized at the intermediate level of the spot color plate in converting the input image signals 54 into the output image signals 120.

### [Remarks]

The present invention is not limited to the above embodiment, but the embodiment can freely be changed or modified without departing from the scope of the invention.

According to the above embodiment, the spot color conversion table 130 (the gradation conversion characteristic curves 106, 112) is represented by a quadratic curve. However, the spot color conversion table 130 is not limited to such a function form, but may be any of various non-linear function forms including functions of third or higher orders, an exponential function, etc., in addition to a quadratic function.

According to the above embodiment, the spot color conversion table 130 is a table for converting one-dimensional values (halftone %) into three-dimensional values (L*, a*, b*). However, the spot color conversion table 130 is not limited to such input and output characteristics, but may have different numbers of output dimensional values (numbers of color plates) including one-dimensional, two-dimensional, four-dimensional, or higher-dimensional values, which may be defined as device-dependent values or device-independent values.

According to the above embodiment, the spot color conversion table 130 is used as spot color converting conditions. However, spot color converting conditions are not limited to such a data format, but may be represented by matrix elements, function expressions, coefficients, various items of information for constructing a learning model, or any of combinations thereof, in addition to lookup tables.

According to the above embodiment, the output image signals 120 are supplied to the printing apparatus 14. However, the output image signals 120 may be supplied to an output apparatus capable of outputting images, e.g., a display apparatus.

What is claimed is:

1. A color conversion processing apparatus for converting input image signals, which include original image signals of process color plates and an original image signal of a spot color plate, into output image signals of process color plates, comprising:
a hue angle calculator configured to calculate a hue angle of a spot color based on spot color information that defines the spot color;
a spot color converting condition determiner configured to determine a spot color converting condition depending on the hue angle that is calculated by the hue angle calculator; and
a color conversion processor configured to convert the original image signal of the spot color plate into an auxiliary-component image signal representing a color component of a process color plate according to the spot color converting condition that is determined by the spot color converting condition determiner.

2. The color conversion processing apparatus according to claim 1, wherein the color conversion processor comprises:
a first color converter configured to convert the original image signal of the spot color plate into an intermediate image signal of a device-independent color plate, using the spot color converting condition; and
a second color converter configured to convert the intermediate image signal that is converted by the first color converter into the auxiliary-component image signal by having an output profile act thereon.

3. The color conversion processing apparatus according to claim 2, wherein the spot color converting condition determiner classifies an entire range that can be taken by the hue angle into a plurality of partial ranges, and determines the spot color converting condition depending on whether the hue angle belongs to either one of the partial ranges or not.

4. The color conversion processing apparatus according to claim 2, wherein the spot color converting condition determiner determines a gradation conversion characteristic curve representing a relationship between a gradation level of the spot color plate and color components that define a device-independent color, as the spot color converting condition.

5. The color conversion processing apparatus according to claim 4, wherein the spot color converting condition determiner determines the gradation conversion characteristic curve which converts a lowest level of the spot color plate into color values of an output medium and converts a highest level of the spot color plate into color values of the spot color, as the spot color converting condition.

6. The color conversion processing apparatus according to claim 1, further comprising:
a process color converter configured to convert the original image signals of the process color plates into main-component image signals of process color plates by having an input profile and an output profile act successively thereon; and
a signal adder configured to add the auxiliary-component image signal converted by the color conversion processor to the main-component image signals converted by the process color converter to obtain the output image signals.

7. A color conversion processing method for converting input image signals, which include original image signals of process color plates and an original image signal of a spot color plate, into output image signals of process color plates, the color conversion processing method enabling a computer to perform the steps of:
calculating a hue angle of a spot color based on spot color information that defines the spot color;
determining a spot color converting condition depending on the calculated hue angle; and
converting the original image signal of the spot color plate into an auxiliary-component image signal representing a color component of a process color plate according to the determined spot color converting condition.

8. A non-transitory storage medium storing a color conversion processing program for converting input image signals, which include original image signals of process color plates and an original image signal of a spot color plate, into output image signals of process color plates, the color conversion processing program enabling a computer to perform the steps of:
calculating a hue angle of a spot color based on spot color information that defines the spot color;
determining a spot color converting condition depending on the calculated hue angle; and
converting the original image signal of the spot color plate into an auxiliary-component image signal representing a color component of a process color plate according to the determined spot color converting condition.
